(19) United States
(12) Patent Application Publication
(10) Pub. No.: US 2007/0096860 A1
(43) Pub. Date: May 3, 2007

(54) Compact MEMS thermal device and method of manufacture

(75) Inventors: John S. Foster, Santa Barbara, CA (US); Paul J. Rubel, Santa Barbara, CA (US)

Correspondence Address: Jaquelin K. Spong, Apt. A1, 2246 Mohegan Drive, Falls Church, VA, 22043, US

(73) Assignee: Innovative Micro Technology, Goleta, CA (US)

(21) Appl. No.: 11/263,912

(22) Filed: Nov. 2, 2005

(51) Int. Cl. H01H 61/00

(52) U.S. Cl. 337/36

(57) ABSTRACT

A MEMS thermal device is made in a smaller size by decreasing the distance that the two cantilevered portions, a spring cantilever and a latch cantilever, of the device must travel. The smaller distance is accomplished by positioning the two contact surfaces of the spring cantilever and the latch cantilever adjacent to each other in the quiescent state of the switch. When the switch is closed, the spring cantilever moves laterally to clear the contact surface of the latch cantilever, and then the latch cantilever moves its contact surface into position. To close the switch, the spring cantilever is allowed to relax and return to nearly its original position, except for the presence of the latch contact surface. When the spring cantilever is allowed to relax, it stays in the closed position because of friction or because of an angled shape of the contact surfaces.

### CROSS REFERENCE TO RELATED APPLICATIONS

Not applicable.

### STATEMENT REGARDING FEDERALLY SPONSORED RESEARCH

Not applicable.

### STATEMENT REGARDING MICROFICHE APPENDIX

Not applicable.

### BACKGROUND

This invention relates to a compact microelectromechanical systems (MEMS) thermal device, and its method of manufacture. More particularly, this invention relates to a compact MEMS thermal switch for switching electrical signals.

Microelectromechanical systems (MEMS) are very small moveable structures made on a substrate using lithographic processing techniques, such as those used to manufacture semiconductor devices. MEMS devices may be moveable actuators, valves, pistons, or switches, for example, with characteristic dimensions of a few microns to hundreds of microns. A moveable MEMS switch, for example, may be used to connect one or more input terminals to one or more output terminals, all microfabricated on a substrate. The actuation means for the moveable switch may be thermal, piezoelectric, electrostatic, or magnetic, for example.

FIG. 1 shows an example of a prior art thermal switch, such as that described in U.S. Patent Application Publication 2004/0211178 A1. The thermal switch 10 includes two cantilevers, 100 and 200. Each cantilever 100 and 200 contains a flexor beam 110 and 210, respectively. A conductive circuit 120 and 220, is coupled to each flexor beam 110 and 210 by a plurality of dielectric tethers 150 and 250, respectively. When a voltage is applied between terminals 130 and 140, a current is driven through conductive circuit 120. The Joule heating generated by the current causes the circuit 120 to expand relative to the unheated flexor beam 10. Since the circuit is coupled to the flexor beam 110 by the dielectric tether 150, the expanding conductive circuit drives the flexor beam in the upward direction 165.

Applying a voltage between terminals 230 and 240 causes heat to be generated in circuit 220, which drives flexor beam 210 in the direction 265 shown in FIG. 1. Therefore, one beam 100 moves in direction 165 and the other beam 200 moves in direction 265. These movements may be used to open and close a set of contacts located on contact flanges 170 and 270, each in turn located on tip members 160 and 260, respectively. The sequence of movement of contact flanges 170 and 270 on tip members 160 and 260 of switch 10 is shown in FIGS. 2a-2d, to close and open the electrical switch 10.

To begin the closing sequence, in FIG. 2a, tip member 160 and contact flange 170 are moved about 10 μm in the direction 165 by the application of a voltage between terminals 130 and 140. In FIG. 2b, tip member 260 and contact flange 270 are moved about 17 μm in the direction 265 by application of a voltage between terminals 230 and 240. This distance is required to move twice the 5 μm width of the contacts, a 4 82 m initial offset between the contact flanges 170 and 270, and additional margin for tolerances of 3 μm. In FIG. 2c, tip member 160 and contact flange 170 are brought back to their initial position by removing the voltage between terminals 130 and 140. This stops current from flowing and cools the cantilever 100 and it returns to its original position. In FIG. 2d, tip member 260 and contact flange 270 are brought back to nearly their original position by removing the voltage between terminals 230 and 240. However, in this position, tip member 160 and contact flange 170 prevent tip member 260 and contact flange 270 from moving completely back to their original positions, because of the mechanical interference between contact flanges 170 and 270. In this position, contact between the faces of contact flanges 170 and 270 provides an electrical connection between cantilevers 100 and 200, such that in FIG. 2d, the electrical switch is closed. Opening the electrical switch is accomplished by reversing the movements in the steps shown in FIGS. 2a-2d.

### SUMMARY

In general, the larger the size of the switch, the higher the cost because fewer devices may be made on the area of the wafer substrate. Therefore, it is advantageous from a cost perspective to make the switches as small as possible. One drawback of switch 10 shown in FIG. 1 is the relatively large distance that tip member 260 and contact flange 270 must travel in order to clear tip member 160 and contact flange 170. Because of this rather large distance, about 17 μm, the cantilever 200 must be made of a size to have sufficient compliance to be able to travel this distance given the temperature change provided by the drive circuit 220. In particular, cantilever 200 is required to be at least about 400 μm long, in order to have sufficient compliance to move the required distance.

Attempting to miniaturize the switch shown in FIG. 1 is not straightforward. A first problem is that the displacement of the cantilevers 100 or 200 does not vary linearly with the beam length, but rather varies rather to a higher power, so the MEMS switch 10 cannot be simply scaled down to reduce its size. Also, if an attempt is made to miniaturize the switch shown in FIG. 1, the drive loop will be shorter, and therefore will not generate the heat necessary to move the cantilevers 100 and 200 the required distances. The drive loops 120 and 220 will also not have as much heat capacity, and the thermal transfer rate to the substrate will be greater, resulting in less heat buildup in the drive loops 120 and 220, and therefore less thermal displacement.

A compact MEMS thermal switch is disclosed herein which has substantially reduced size compared to switch 10 shown in FIG. 1. Accordingly, the switch described herein may have cost advantages relative to the switch shown in FIG. 1. In addition, the switch described here may be more robust during a shock event than the switch illustrated in FIG. 1. Finally, the switch described herein may have a simpler activation sequence than that illustrated in FIGS. 2a-2d.

The compact MEMS thermal switch is one embodiment of the more general compact MEMS device. The compact MEMS device comprises a first cantilevered thermal actuator with a first contact and a second cantilevered thermal actuator with a second contact, wherein the first cantilevered thermal actuator is less stiff than the second cantilevered thermal actuator, and wherein the first cantilevered thermal actuator moves a greater distance than the second cantilevered thermal actuator to activate the device by engaging the first contact with the second contact.

The MEMS thermal switch embodiment may have two cantilevered beams, with one cantilevered beam being less stiff than the other. Each cantilevered beam may also have a tip member with a contact and a contact surface. In the quiescent state, the contacts on the tip members of the cantilevered beams are directly adjacent to one another. To close the MEMS switch, the second stiffer cantilever swings away to clear the adjacent contact of the tip member of the first cantilever. The first cantilever then deflects into a flexed position, whereupon the second cantilever relaxes to approximately ⅔ of it stroke causing the two contacts to touch thus closing the switch. The second cantilever then holds the first cantilever in the displaced position, despite the restoring force acting upon the first cantilever, thus the switch is latched. In one exemplary embodiment, frictional forces keep the cantilevers from becoming unlatched. In another exemplary embodiment, the contact surfaces of the cantilevers are angled to prevent unlatching, even in the situation where no friction is present.

Because the cantilevered beams are arranged with their contacts adjacent, the cantilevered beams are not required to travel as far, because the second cantilever has only to clear the width of the contact on the first cantilever. Because of the smaller amount of travel required of the first and the second cantilevers, the beams may be made shorter, and thus the entire switch may be made more compact than the switch illustrated in FIG. 1.

Another advantage of this design is that the two cantilevers may be optimized independently, because their functions and movements are different. That is, the cantilevers may be made with dissimilar mechanical attributes, the first enhancing the travel of the cantilever at the expense of its stiffness, and the second enhancing the stiffness at the expense of reduced travel.

Because the second cantilever may be made very stiff, it can hold the first cantilever in the latched position even in the event of shock, and despite the restoring force of the first cantilever tending to unlatch the first cantilever from the second.

These and other features and advantages are described in, or are apparent from, the following detailed description.

### BRIEF DESCRIPTION OF THE DRAWINGS

Various exemplary details are described with reference to the accompanying drawings, which however, should not be taken to limit the invention to the specific embodiments shown but are for explanation and understanding only.

FIG. 1 is a schematic view of a prior art MEMS thermal switch;

FIGS. 2a-2d are diagrams illustrating the sequence of movements required to close the switch illustrated in FIG. 1;

FIG. 3 is a schematic view of an exemplary MEMS thermal switch;

FIGS. 4a-4d are diagrams illustrating an exemplary sequence of movements;

FIG. 5 is a schematic view showing greater detail of an exemplary shape of the angle contact flanges;

FIG. 6 is a schematic view showing the functioning of the angled contact flange of FIG.;

FIGS. 7a-7d are diagrams illustrating an exemplary sequence of movements for the angled contact flanges of FIG. 5;

FIG. 8 illustrates a second exemplary shape of the angled contact flanges;

FIG. 9 illustrates a first step in the fabrication of the compact MEMS switch;

FIG. 10 illustrates a second step in the fabrication of the compact MEMS switch;

FIG. 11 illustrates a third step in the fabrication of the compact MEMS switch;

FIG. 12 illustrates a fourth step in the fabrication of the compact MEMS switch; and

FIG. 13 illustrates a fifth step in the fabrication of the compact MEMS switch;

### DETAILED DESCRIPTION

Although the devices and methods described herein are applied to an electrical switch, it should be understood that this is only one embodiment, and that the device and methods may include any number of devices, such as valves and actuators.

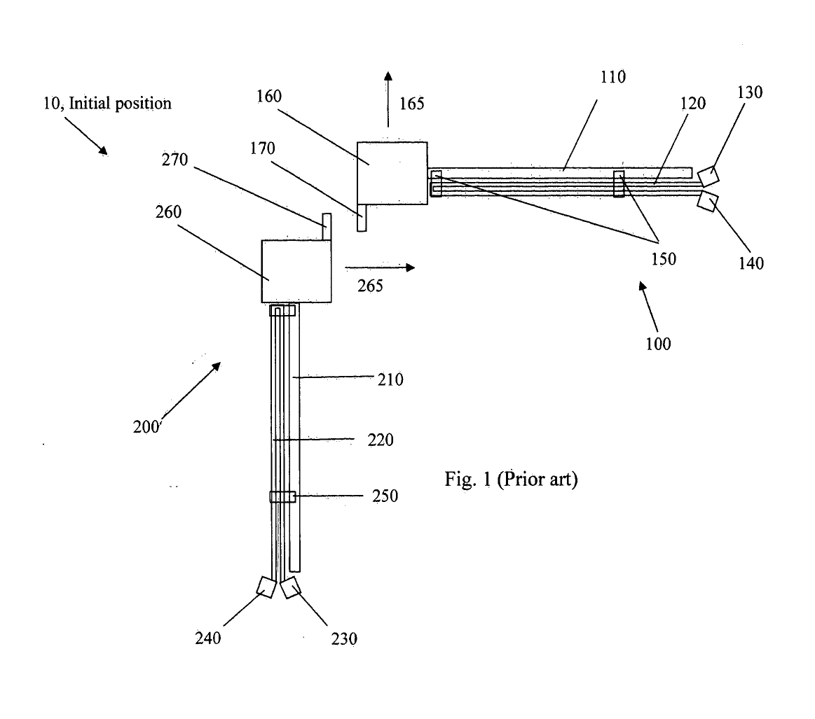

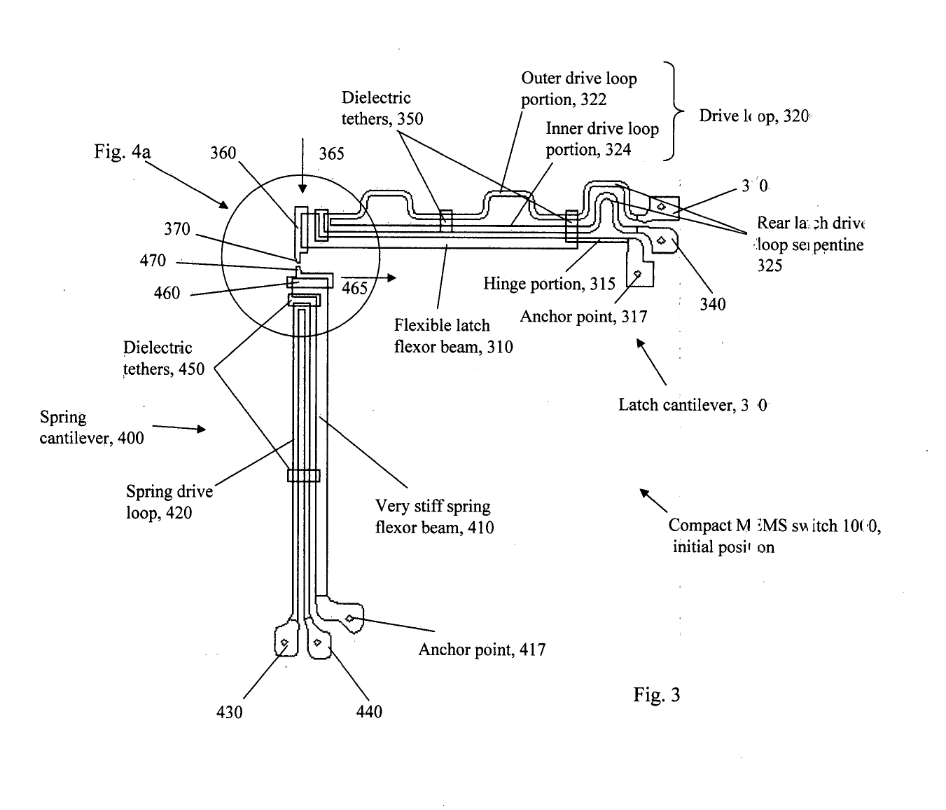

FIG. 3 is a schematic view of an exemplary compact MEMS thermal switch 100. Like the MEMS switch 10 illustrated in FIG. 1, the compact MEMS switch 1000 includes two cantilevers. The first cantilever will be hereinafter referred to as the “latch” cantilever 300, and the second cantilever will be referred to as the “spring” cantilever 400. The latch cantilever 300 and the spring cantilever 400 both include a cantilevered flexor beam 310 and 410, respectively, and a drive loop circuit 320 and 420, respectively. The flexor beams 310 and 410 and the drive loops 320 and 420 each have proximal and distal ends, with the proximal end of the flexor beams 310 and 410 coupled to anchor points 317 and 417, respectively, and the proximal ends of the drive loops 320 and 420 coupled to terminals 330 and 340, and 430 and 440, respectively.

In the embodiment depicted in FIG. 3, the flexor beams 310 and 410 will carry the signal being switched. Therefore, the flexor beams 310 and 410 may be made of any suitably conductive material. In one exemplary embodiment, nickel is chosen because it is a straightforward material to plate, as will be described below. However, in order to isolate the signal carrying flexor beams 310 and 410 from the drive loop circuits 320 and 420, the drive loop circuits 320 and 420 will be tethered to the flexor beams 310 and 410 by dielectric tethers 350 and 450, respectively, which are electrically insulating but mechanically rigid materials. The drive loop circuits 320 and 420 may also be made of nickel, and formed at the same time as the cantilevered flexor beams 310 and 410.

As can be seen in FIG. 3, the compact MEMS switch 1000 also includes two tip members 360 and 460, to which two contacts 370 and 470 are affixed. Like the prior art switch 10, the tip members 360 and 460 and the two contacts 370 and 470 may be made of different material than cantilevered flexor beams 310 and 410. The material of tip members 360 and 460 and contacts 370 and 470 may be made of a material which has a low contact resistance relative to the material of cantilevered flexor beams 310 and 410. In one embodiment, the material of tip members and contacts 360, 460, 370 and 470 is gold, however, other materials such as gold cobalt alloy, palladium, etc., may be used as well.

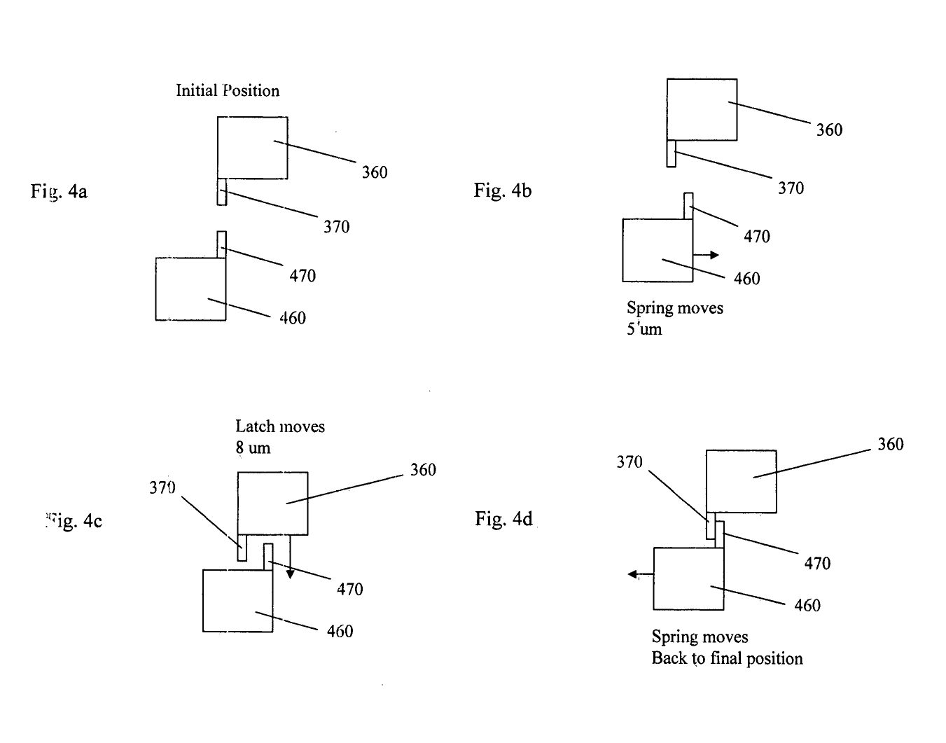

In contrast to MEMS switch 10, in the quiescent state, the two contacts 370 and 470 of compact MEMS switch 1000 are located adjacent to each other, rather than one in front of the other as is the case with contact flanges 170 and 270 shown in FIG. 1. The initial position of contact 370 relative to contact 470 is shown schematically in FIG. 4a. By being “adjacent” to each other, it should be understood that the spring contact 470 and latch contact 370 have one dimension longer than the other, and in a quiescent state, surfaces having the shorter dimension are located a minimum distance apart.

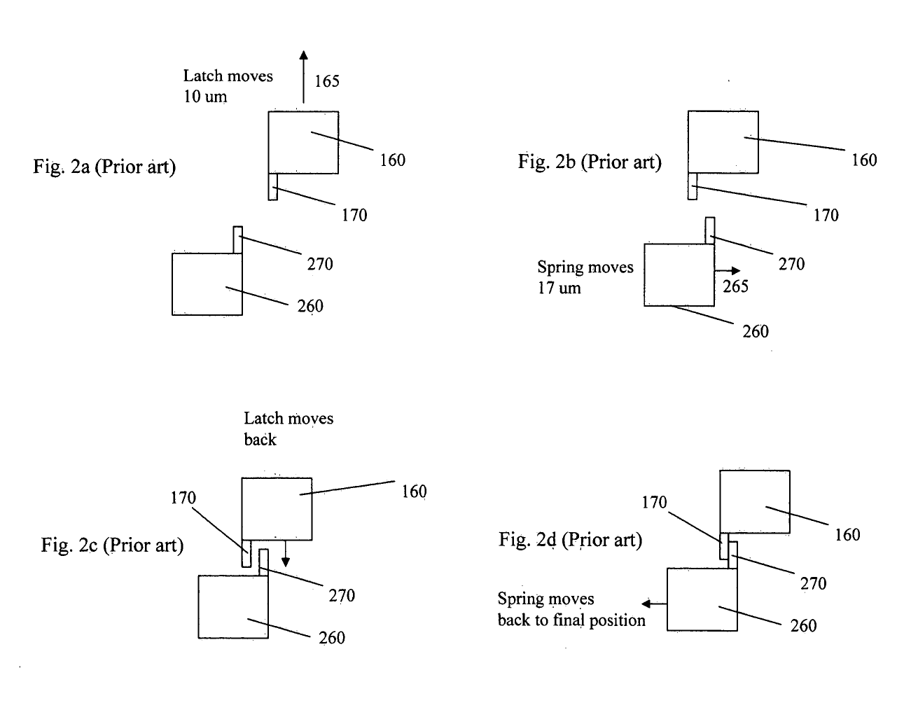

Because of the location of contact flanges 370 and 470 adjacent to one another, contact flange 370 does not need to be retracted as was shown in FIG. 2a. Instead, the sequence of motion for the compact MEMS switch 1000 is shown in FIGS. 4b-4d. In FIG. 4b, spring drive loop 420 is energized by applying a voltage to terminals 430 and 440. The resulting current flowing through spring drive loop 420 causes the drive loop 420 to rise in temperature and expand. Because spring drive loop 420 is tethered to spring flexor beam 410 by dielectric tethers 450, the expansion of spring drive loop 420 causes the spring flexor beam 410 to arc in the direction 465 shown in FIG. 3. This moves the spring tip member 460 along with spring contact flange 470 as shown in FIG. 4b. However, in contrast to the motion depicted in FIG. 2b, the distance that the spring cantilever 400 must move is only the width of the contact 370, about 5 μm. This has a substantial impact on the mechanical characteristics of the spring beam. Specifically, because the travel distance of spring beam 400 is relatively small, the relative stiffness of spring beam may be made large compared to the stiffness of the latch beam. In one exemplary embodiment, the spring cantilever stiffness is about 140 N/m.

The dielectric tethers 350 and 450 may be made of any convenient, non-conducting material which couples the drive loops 320 and 420 to cantilevered flexor beams 310 and 410 mechanically, but not electrically. In one embodiment, dielectric tethers 350 and 450 may be made from an epoxy based photoresist such as SU-8, a negative photoresist developed by IBM of Armonk, N.Y.

After the spring beam has moved 5 μm, the latch drive loop 320 is energized by applying a voltage to terminals 330 and 340. This resulting current flowing through latch drive loop 320 causes the latch drive loop to rise in temperature and expand. Because the latch drive loop 320 is tethered to the latch flexor beam 310 by dielectric tethers 350, the expansion of latch drive loop 320 causes the latch flexor beam 310 to arc in the direction 365 shown in FIG. 3. This moves the latch tip member 360 along with latch contact flange 370 as shown in FIG. 4c, a total distance of about 8 μm. Because the latch cantilever 300 moves a larger distance than the spring cantilever 400, it may be made relatively flexible. Several features contribute to the greater displacement capability of the latch cantilever 300, compared to spring cantilever 400.

First, the latch beam 310 may be made with a narrower hinge portion 315 in the area where it is anchored to the substrate. This may make the latch flexor beam 310 less rigid, and therefore it may have a greater displacement as a function of temperature. Secondly, the drive loop may be made with an outer portion 322 and an inner portion 324, with the outer portion 322 located further away from the cantilevered flexor beam 310 than the inner portion 324. The outer portion 322 of the latch drive loop 320 may. then be formed with a serpentine shape, as shown in FIG. 3. As the latch flexor beam 310 bends during actuation, it forms an arc. In order for the latch flexor beam 310 to take the shape of an arc, with minimum stress, the outer portion 322 of the drive loop 320 will need to be elongated more along the longitudinal axis of the flexor beam 310 than an inner portion 324 of the drive loop, because it is farther away from the axis of curvature. The serpentine shape allows the outer portion 322 of drive loop 320 to expand more easily than the inner portion 324 of the drive loop, and therefore reducing the binding between the inner portion 324 and outer portion 322 of the drive loop 320, and thus enhances the thermal displacement created by the drive loop 320. The addition of these serpentines will also reduce the bending stiffness of the latch cantilever beam structure 300. Rear serpentines 325 in both the outer portion 322 and inner portion 324 of the drive loop 320 again decrease the stiffness of the latch cantilever 300 at its base. Each of these features is designed to increase the displacement of the latch cantilever for a given temperature, at the expense of latch stiffness. However, as will be described further below, the latch beam is not required to have much stiffness, as the contact force for the contact flanges 370 and 470 will be provided by the spring cantilever 400, rather than the latch cantilever.

One drawback to the compact MEMS switch 1000 is that the longitudinal length of the drive loops are shorter, thus having lower electrical resistance which will reduce the maximum temperature the drive loops will achieve with the same voltage applied. Increasing the voltage is not a good solution due to the increased costs of controlling CMOS chips that can operate at higher currents. Therefore, an additional advantage of the rear latch drive loop serpentine 325 is that it adds length to the drive loop without adding length to the flexor beam 310. This additional length may increase the temperature achieved by the latch drive loop 320, thus increasing its displacement during actuation. In fact, the presence of the serpentine shape may increase the peak temperature achieved by the drive loop 320 by about 200 degrees centigrade. The displacement of the cantilevered flexor beam 310 can be further increased by forming the outer portion 322 of the drive loop 320, narrower than the inner portion 324. In one embodiment, the width of the outer portion 322 of the drive loop 320 is 4.5 μm whereas the width of the inner portion 324 of the drive loop 320 is 5.0 μm. This will cause the outer portion 322 of drive loop 320 to generate more heat than the inner portion 324, and therefore encourage bending in direction 365.

The dielectric tethers 350 are placed in the serpentine portion of drive loop 320 as shown in FIG. 3. The placement of dielectric tethers 350 is chosen to transmit as much of the thermal displacement of drive loop 320 to cantilevered flexor beam 310 as possible, without increasing the overall stiffness of cantilever 300 to bending about the anchor point 317. To achieve this purpose, no dielectric tethers are placed over the rear latch serpentine 325, that is, the area closest to the anchor point 317, such that this area is free to bend. The overall dimensions of the dielectric tethers 350 and 450 are generally made as small as practical without sacrificing mechanical strength, in order to reduce heat transfer to the cantilevered flexor beams 310 and 410, which would otherwise reduce the bending displacement generated by the drive loops 320 and 420. Exemplary dimensions of dielectric tethers are about 10 μm by 25 μm.

The latch cantilever made according to the design shown in FIG. 3 may have a cantilever stiffness of about 14 N/m, compared to the spring cantilever stiffness of about 140 N/m as set forth above. Accordingly, the latch beam generates about 1/10 of the force of the spring beam. In one exemplary embodiment, in the latched position, the latch beam may generate a force of about 60 μN, whereas the spring beam may generate a force of about 500 μN.

Because the travel distances are small, the total length of the spring cantilever 400 and latch cantilever 300 may be made substantially smaller than the prior art switch shown in FIG. 1. In fact, one embodiment of the compact MEMS thermal switch 1000 has a cantilever length of only 230 μm, compared to a cantilever length of 440 μm for the prior art switch shown in FIG. 1. This may shrink the area required for the entire switch package to an area of only about 66% of the switch package required for the prior art MEMS thermal switch, including overhead areas such as bond pad regions, etc. As described above, the total area of substrate required by the compact MEMS switch package directly impacts the cost of manufacturing the switch, and therefore compact MEMS switch 1000 may be expected to be substantially cheaper to manufacture than prior art MEMS switch 10.

For a spring cantilever 400 made according to the design shown in FIG. 3, the displacement of the contact 470 is about 5 μm for a drive current of 180 mA. For a latch cantilever 300 made according to the design shown in FIG. 3, including the drive loop serpentine features and narrowed hinge portion 315, the displacement of the latch contact 370 of the latch cantilever 300 is about 10.5 μm for a 180 mA drive current. This corresponds to an angular deflection of between about 1 and 3 degrees for cantilevers 300 and 400.

In FIG. 4d, the switch is closed by allowing the spring cantilever 400 to relax to 80 percent of its initial displacement. This is achieved by removing the voltage applied to terminals 430 and 440. As the current ceases to flow, the spring drive loop 420 cools, and shrinks, pulling the spring flexor beam 410 back to nearly it original position. However, the presence of the latch contact 370 prevents the spring contact 470 from moving further than the position shown in FIG. 4d, in which it is resting against, and engaged with, the latch contact. In this position, the latch contact and the spring contact form an electrical connection, such that an electrical signal is allowed to pass from the latch cantilever 300 to the spring cantilever 400, thereby closing the switch. Opening the MEMS switch 1000 is accomplished by energizing the spring cantilever 400, which releases the latch cantilever 300. The latch cantilever 300 then returns to its initial position shown in FIG. 4a, because of the restoring force of the latch cantilevered flexor beam 310.

A comparison of the sequence of motion for the compact MEMS switch 1000 shown in FIGS. 4b-4d with the sequence of motion for the prior art MEMS switch 10 shown in FIGS. 2a-2d reveals that the sequence of motion is one step shorter for the compact MEMS switch 1000 than for the prior art MEMS switch 10. This is because the first retraction step shown in FIG. 2a is absent in the sequence for the compact MEMS switch 1000. Therefore, the control algorithm for the compact MEMS switch 1000 is somewhat simpler than that for the prior art MEMS switch 10. Simplifying the control algorithm may have the advantage of decreasing the cost of the mating electrical componets for the device.

As can be seen in FIGS. 4a-4d, the spring cantilever, and not the latch cantilever, provides the force necessary to close the switch. Furthermore, in the closed state, the latch cantilever is held in the deflected position, under tension, by the spring cantilever. In fact, with the design shown in FIGS. 4a-4d, the only force keeping the switch closed is friction between the latch contact flange 370 and the spring contact flange 470. For many situations, this may provide a satisfactory and reliable switch.

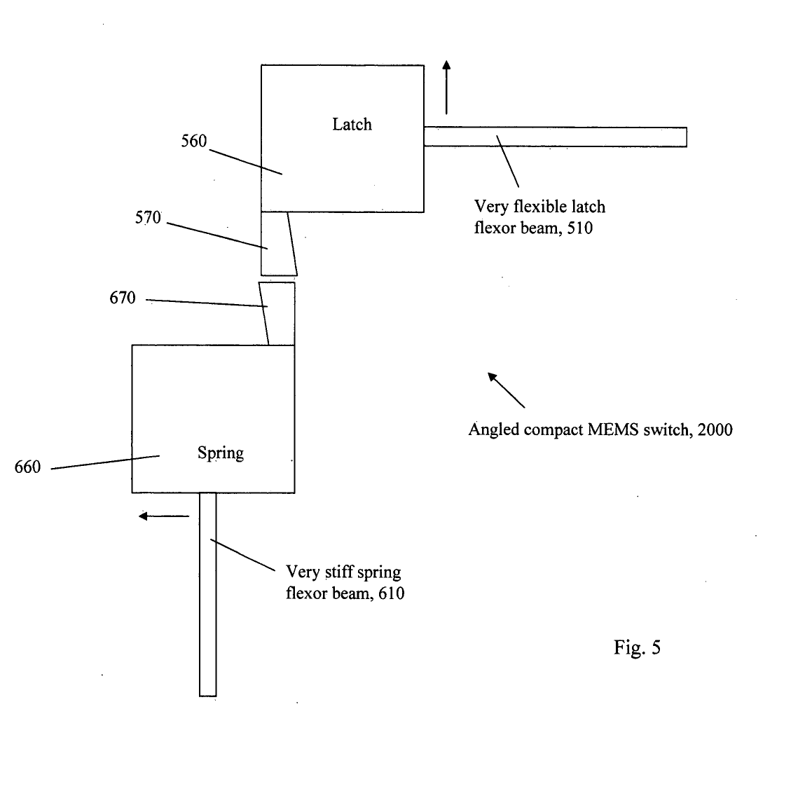

However, an alternative embodiment for the latch contact 370 and the spring contact 470 which does not rely on friction is the angled latch contact 570 and angled spring contact 670. Like the embodiment illustrated in FIGS. 4a-4d, the angled contacts 570 and 670 start in the initial position shown in FIG. 5, in which the angled contacts 570 and 670 are in an adjacent arrangement.

In the closed position, the spring contact 670 holds the latch contact 570 in the deflected position. However, when the switch is closed, the angled contacts form a contact surface 580, which is disposed at an angle with respect to the tip members 560 and 660. The angled contact surface 580 may retain the engagement of the tip members 560 and 660, without relying on friction.

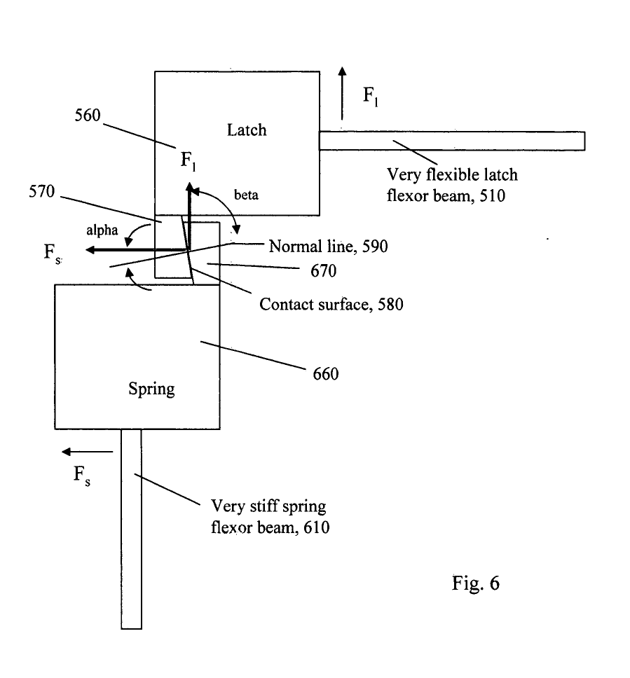

In particular, the normal line to the contact surface 580 is the line designated by reference numeral 590 in FIG. 6. This line 590 defines the angles alpha and beta, which are the angles at which the spring force Fₛ, and latch force, Fₗ, respectively are applied to the contact surface 580. In general, alpha=90−beta, where alpha is the latch angle. Inspection of FIG. 5 reveals that the larger the latch angle, the more firmly engaged the spring contact 670 with the latch contact 570, however, the farther the spring beam 600 must travel to clear the latch contact 570. In fact, no friction is required to maintain the latched condition as long as Fₛ, and Fₗ, satisfy
Fₗ/cos(beta)<Fₛ sin(alpha) (1)
and the components of Fₗ and Fₛ normal to the contact surface are equal, such that the switch is stationary.

One embodiment of the angled compact MEMS thermal switch 2000 uses a latch angle of about 18 degrees, however, it should be understood that the selection of a latch angle will depend on other details of the design, such as the radius of rotation of the tip members 560 and 660 defined by the length of the cantilevers 500 and 600, and their displacement. It should also be understood that designs with a latch angle of less than about 3 degrees will be relying largely on friction to keep the contacts 570 and 670 engaged, although this limit will also depend on the lengths and displacements required of latch cantilever 500 and spring cantilever 600.

The switch will not become unlatched unless the restoring force (or force due to a shock) Fₗ applied by the latch spring meets:
Fₗ*cos(beta)>Fₛ*cos(alpha) (2)
At this point, the component of the latch force in the normal direction exceeds the component of the spring force in the normal direction, and the latch cantilever is able to move free of the spring cantilever. Since the mass of the latch cantilever is very low, the switch may undergo shocks in excess of 145,000 g before the switch becomes unlatched. This performance may exceed the performance of MEMS switch 10 shown in FIG. 1, because for MEMS switch 10, the switch stays closed under shock only because of friction between the contact flanges 170 and 270. However, the normal force provided by spring beam 210 in MEMS switch 10 is limited, because the spring beam must also travel a relatively long distance, 17 μm, and therefore its stiffness must remain fairly low.

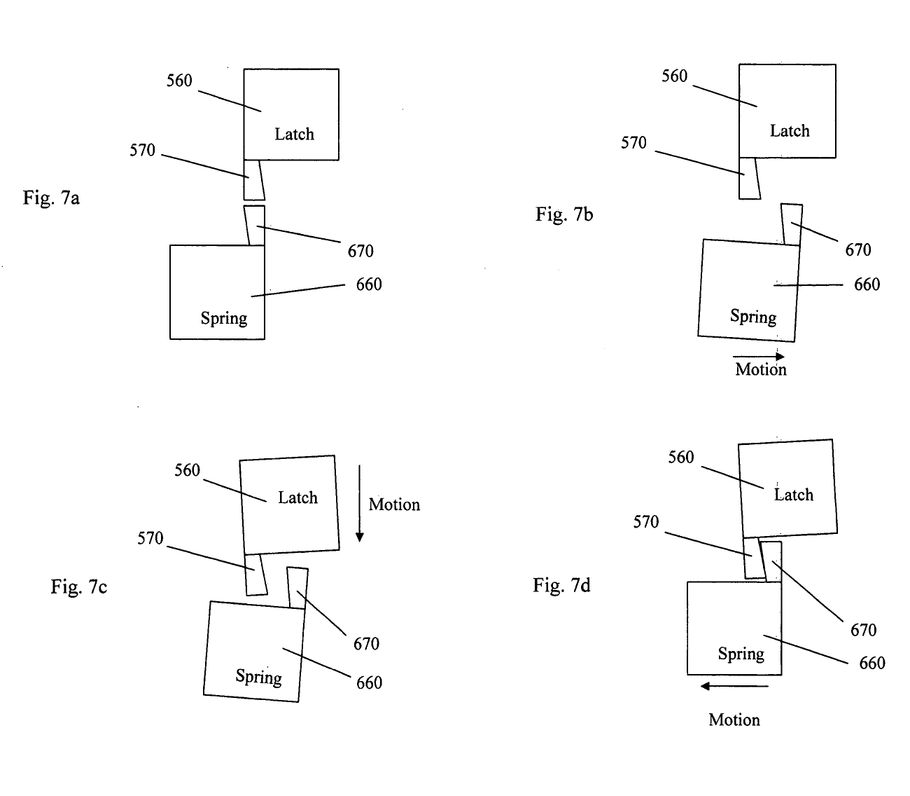

The sequence of motion for the angled compact MEMS switch 2000 is shown in FIGS. 7a-7d. As before with the compact MEMS switch 1000, the angled compact MEMS switch 2000 may lack the first retraction step of the prior art MEMS switch 10. Instead, the first motion, shown in FIG. 7b is the movement of the spring cantilever 600 about 5 μm to clear the latch contact. Since the spring contact 670 is mounted on a cantilever beam, the actual movement of the spring cantilever is in an arc, as indicated by some rotation of the spring tip member 660.

The next motion, illustrated by FIG. 7c, is the movement of the latch cantilever into the closed position. As with the spring cantilever, this motion is on an arc rather than rectilinear, and is therefore accompanied by some rotation of the latch tip member 760, as shown in FIG. 7c.

Finally, the angled compact MEMS switch 2000 is closed by allowing the spring cantilever to relax into a position in which it is latched by the presence of the latch contact 570. In this position, the spring cantilever makes electrical contact with the latch cantilever, so that an electrical signal can travel from the spring cantilever to the latch cantilever, or vice versa.

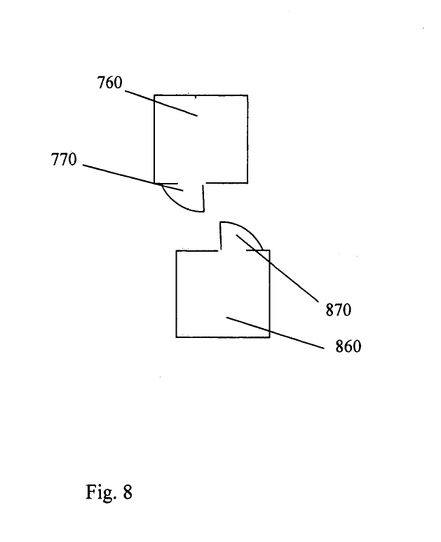

In another embodiment of the spring contact 870 and latch contact 770, one side of the spring contact 870 and latch contact 770 is rounded, to discourage arcing from the spring cantilever 600 to the latch cantilever 500, or vice versa. Such a shape is not generally desired in the prior art MEMS switch 10, because it increases the distance that the cantilevers 100 and 200 must move. However, in this design, because the spring contact and the latch contact start out adjacent to one another, there is no penalty associated with shaping the backsides of the contacts in a more advantageous way, such as that shown in FIG. 8.

Another advantage of compact MEMS switch 1000 and 2000 may be the motion of the one contact 370 or 570 against the other contact 470 or 670. In compact MEMS switch 1000 or 2000, there is a lateral component of motion of the contacts against each other as the switch closes. In the prior art MEMS switch 10, the only motion of the switch upon closure is perpendicular to the contact surfaces 170 and 270. The lateral motion in contact MEMS switch 1000 or 2000 accomplishes a scrubbing action, which may lower the contact resistance between the surfaces. Accomplishing a scrubbing action in prior art MEMS switch 10 requires additional motion which be must be added to the basic motion of closing the switch, by programming the software controlling the switch accordingly. In compact MEMS thermal switch 1000 or 2000, this scrubbing action is an inherent feature of the switch closure motion.

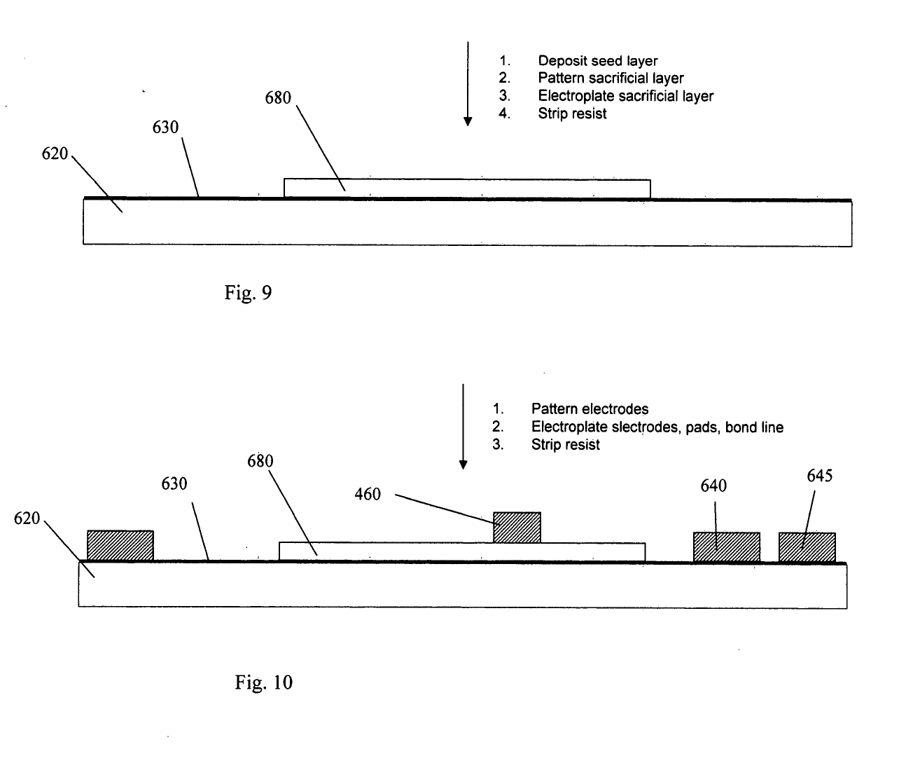

An exemplary method for fabricating the compact MEMS switch 1000 or 2000 will be described next. The compact MEMS switch 1000 or 2000 may be fabricated on any convenient substrate 620, for example silicon, silicon on insulator (SOI), glass, or the like. Because in FIGS. 9-13, the compact MEMS switch is shown in cross section, only one of the two cantilevered beams of the compact MEMS thermal switch is shown. However, it should be understood that the second cantilever 500 may be formed at the same time as, and using identical processes to those used to form the first cantilever 400 which is depicted in the figures.

FIG. 9 illustrates a first exemplary step in the fabrication of the compact MEMS switch 1000 or 2000. The process begins with the deposition of a seed layer 630 for later plating of the MEMS switch cantilever 400, over the substrate 620. The seed layer 630 may be chromium (Cr) and gold (Au), deposited by chemical vapor deposition (CVD) or sputter deposition to a thickness of 100-200 nm. Photoresist may then be deposited over the seed layer 630, and patterned by exposure through a mask. A sacrificial layer 680, such as copper, may then be electroplated over the seed layer. The plating solution may be any standard commercially available or in house formulated copper plating bath. Plating conditions are particular to the manufacturer's guidelines. However, any other sacrificial material that can be electroplated may also be used. In addition, deposition processes other than plating may be used to form sacrificial layer 680. The photoresist may then be stripped from the substrate 620.

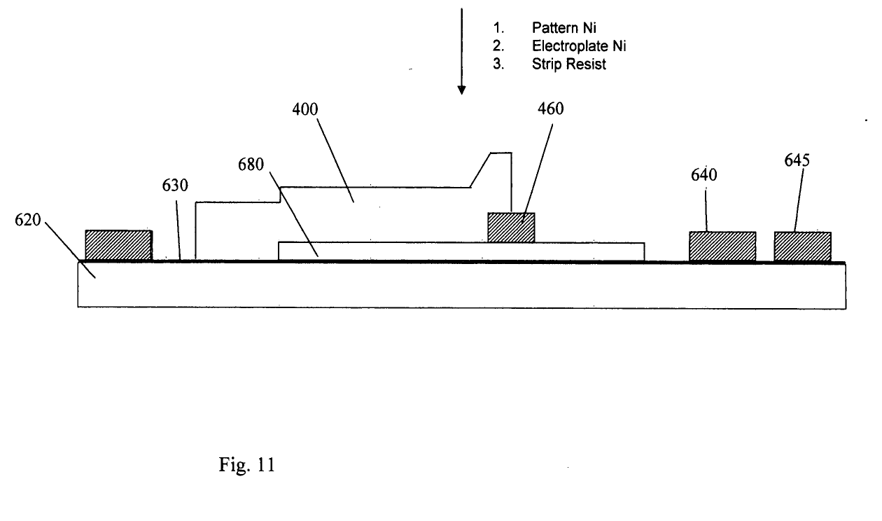

A second exemplary step in fabricating the compact MEMS switch 1000 or 2000 is illustrated in FIG. 10. In FIG. 10, the substrate 620 is again covered with photoresist, which is exposed through a mask with features corresponding to gold pads 640 and 645 and a gold tip member 460. Gold may be used for the tip members 360, 460, 560, 660, 760 and 860 because it may have lower contact resistance than the material that will form the cantilever 600. Although not shown in this view, it should be understood that the features for contacts 370, 470, 570, 670 or 770 may also be formed in this step. The features 460 and 640 will subsequently be plated in the appropriate areas. The gold features 640, 645 may include a bonding ring, which will eventually form a portion of a hermetic seal which may bond a cap layer over the substrate 620 and switch 1000 or 2000. One of the gold features 645 may also be an external access pad that will provide access to the compact MEMS switch 1000 or 2000 electrically, from outside the hermetically sealed structure.

The gold features 640, 645 and 460 may then be electroplated in the areas exposed by the photoresist, to form gold features 640, 645 and 460 and any other gold structures needed. The photoresist is then stripped from the substrate 620. The thickness of the gold features 640, 645 and 460 may be, for example, 1 μm.

FIG. 11 illustrates a third step in fabricating the compact MEMS switch 1000 or 2000. In FIG. 11, photoresist is once again deposited over the substrate 620, and patterned according to the features in a mask. The exposed portions of the photoresist are then dissolved as before, exposing the appropriate areas of the seed layer 630. The exposed seed layer 630 may then be electroplated with nickel to form the flexor beam 410 and drive loop 420 of the cantilever 400 of the compact MEMS switch 1000. The tip member 460 will be affixed to the cantilevered flexor beam 410 by the natural adhesion of the gold to the nickel, after deposition. Although nickel is chosen in this example, it should be understood that any other conductive material that can be electroplated may also be used. In addition, deposition processes other than plating may be used to form conductive cantilever 400. The photoresist may then be stripped from the substrate 620.

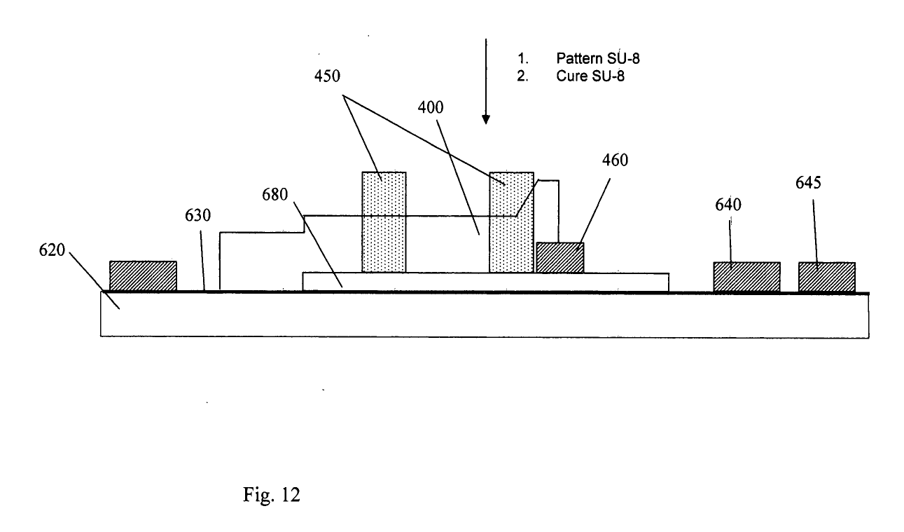

FIG. 12 illustrates a fourth step in the fabrication of the compact MEMS switch 1000 or 2000. In FIG. 12, a polymeric, nonconducting material such as the photoresist SU-8 is deposited over the substrate 620, flexor beam 410 and drive loop 420. The photoresist is then cross-linked, by for example, exposure to UV light. The unexposed resist is then dissolved and removed from the substrate 620 and structure 400 in all areas that the dielectric tether is absent. This step forms the dielectric tether 450, that tethers drive loop 420 to cantilevered flexor beam and 410. The photoresist may then be cured by, for example, baking.

Although not shown, it should be understood that dielectric tether 350, flexor beam 310 and drive loop 320 are formed in a manner similar to that described above for dielectric tether 450, flexor beam 410 and drive loop 420.

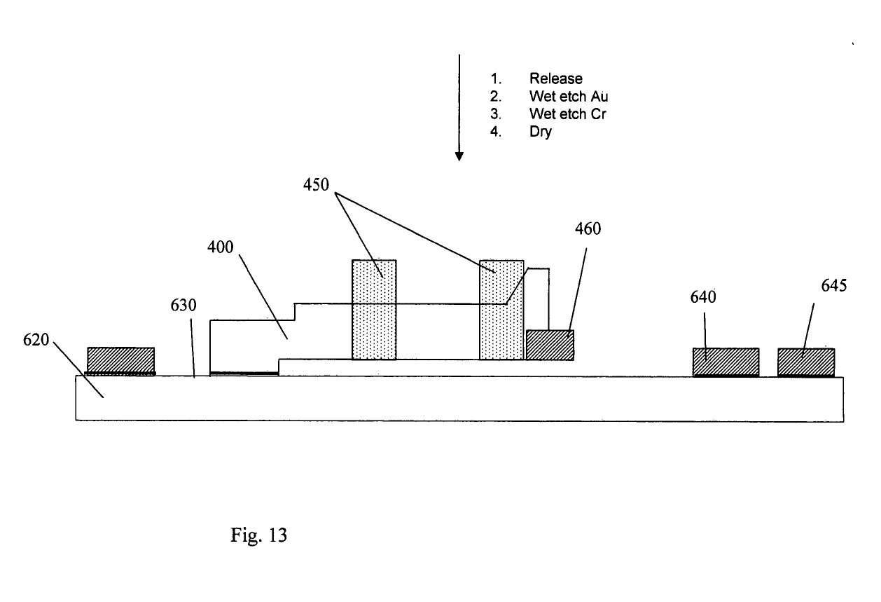

FIG. 13 illustrates a fifth step in the fabrication of the compact MEMS switch 1000 or 2000. In this step, the cantilever 400 may be released by etching the sacrificial copper layer 680. Suitable etchants may include, for example, an isotropic etch using an ammonia-based Cu etchant. The Cr and Au seed layer 630 is then also etched using, for example, a wet etchant such as iodine/iodide for the Au and permanganate for the Cr, to expose the SiO₂ surface of the substrate 620. The substrate 620 and MEMS switch 1000 or 2000 may then be rinsed and dried.

The resulting compact MEMS device 1000 or 2000 may then be encapsulated in a protective lid or cap wafer. Details relating to the fabrication of a cap layer may be found in co-pending U.S. patent application Ser. No. 11/211,625, (Attorney Docket No. IMT-Interconnect) incorporated by reference herein in its entirety.

It should be understood that one gold feature 645 may be used as an external access pad for electrical access to the compact MEMS switch 1000 or 2000, such as to supply a signal to the compact MEMS switch 1000 or 2000, or to supply a voltage the terminals 430 or 440 in order to energize the drive loops of the switch, for example. The external access pad 645 may be located outside the bond line which will be formed upon the bonding of a cap layer to the substrate 620. Alternatively, electrical connections to compact MEMS switch 1000 or 2000 may be made using through-wafer vias, such as those disclosed in co-pending U.S. patent application Ser. No. 11/211,624 (Attorney Docket No. IMT-Blind Trench), incorporated herein by reference in its entirety.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. While the embodiment described above relates to a microelectromechanical switch, it should be understood that the techniques and designs described above may be applied to any of a number of other microelectromechanical devices, such as valves and actuators. Furthermore, details related to the specific design features and dimensions of the compact MEMS switch are intended to be illustrative only, and the invention is not limited to such embodiments. Accordingly, the exemplary implementations set forth above, are intended to be illustrative, not limiting.

1. A micromechanical device, comprising:
a first cantilevered actuator with a first contact; and
a second cantilevered actuator with a second contact, wherein the first cantilevered actuator is less stiff than the second cantilevered actuator, and wherein the first cantilevered actuator moves a greater distance than the second cantilevered actuator to activate the device by engaging the first contact with the second contact.

2. The micromechanical device of claim 1, wherein when the micromechanical device is activated, the first cantilevered actuator is held in a deflected position by the second cantilevered actuator.

3. The micromechanical device of claim 1, wherein in a quiescent state, the first contact is disposed substantially adjacent to the second contact.

4. The micromechanical device of claim 1, wherein the first cantilevered actuator and the second cantilevered actuator each further comprises a drive loop which deflects a cantilevered flexor beam having proximal and distal ends.

5. The micromechanical device of claim 4, wherein the drive loop of the first cantilevered actuator is formed in a serpentine shape and is coupled to the cantilevered flexor beam with at least one dielectric tether.

6. The micromechanical device of claim 5, wherein the cantilevered flexor beam and drive loop comprise nickel, the contacts comprise gold, and the dielectric tether comprises an epoxy-based photoresist.

7. The micromechanical device of claim 4, wherein the cantilevered flexor beam of the first cantilevered actuator has a narrowed portion near its proximal end.

8. The micromechanical device of claim 1, wherein the first contact and the second contact have angled adjacent faces which maintain engagement of the first and second contacts.

9. The micromechanical device of claim 1, wherein at least one of the first contact and the second contact has a rounded face on a side opposite from a contact surface.

10. The micromechanical device of claim 1, wherein the first cantilevered actuator is designed to move about 8 μm when actuated, and the second cantilevered actuator is designed to move about 5 μm when actuated.

11. The micromechanical device of claim 2, wherein the drive loop comprises and inner loop and an outer loop, wherein the inner loop is closer to the cantilevered flexor beam and has lower resistance than the outer loop.

12. A method of making a micromechanical device, comprising:
forming a first cantilevered actuator with a first contact; and
forming a second cantilevered actuator with a second contact, wherein the first cantilevered actuator is less stiff than the second cantilevered actuator, and wherein the first cantilevered actuator moves a greater distance than the second cantilevered actuator to activate the device by engaging the first contact with the second contact.

13. The method of claim 12, wherein forming the first cantilevered actuator and forming the second cantilevered actuator further comprise forming a drive loop and a cantilevered flexor beam having proximal and distal ends.

14. The method of claim 12, wherein forming the first cantilevered actuator with the first contact and forming the second cantilevered actuator with the second contact comprises forming the first and second contacts with angled faces which maintain engagement of the first and second contacts.

15. The method of claim 13, wherein forming the drive loop comprises forming the drive loop with a serpentine shape and coupling the flexor beam to the drive loop with at least one dielectric tether.

16. The method of claim 12, further comprising: forming the first cantilevered actuator and first contact such that in a quiescent state, the first contact is disposed substantially adjacent to the second contact.

17. The method of claim 13, further comprising forming the cantilevered flexor beam of the first cantilevered actuator with a narrowed portion on the proximal end of the cantilevered flexor beam.

18. The method of claim 13, wherein forming the drive loop further comprises forming a drive loop with an inner and an outer portion, wherein the inner portion is disposed nearer to the cantilevered flexor beam than the outer portion and is wider than the outer portion.

19. A method of using the micromechanical device of claim 1, comprising:
energizing the second cantilevered actuator;
energizing the first cantilevered actuator;
de-energizing the second cantilevered actuator; and
allowing the second cantilevered actuator to relax to close the device.

20. The method of using the micromechanical device of claim 17, further comprising:
energizing the second cantilevered actuator to release the first cantilevered actuator, thereby opening the device.
